(19) United States
(12) Patent Application Publication
(10) Pub. No.: US 2015/0281415 A1
(43) Pub. Date: Oct. 1, 2015

(54) METAL PROTECTOR FRAME ASSEMBLY FOR MOBILE PHONE

(71) Applicant: Shu-Wei Lin, Taichung City (TW)

(72) Inventor: Shu-Wei Lin, Taichung City (TW)

(21) Appl. No.: 14/228,313

(22) Filed: Mar. 28, 2014

(51) Int. Cl. H04M 1/02

(52) U.S. Cl. CPC H04M 1/0249

(57) ABSTRACT

The frame assembly includes a first frame and a second frame, which correspond to each other. The first frame has a first peripheral wall. The second frame is attached with the first peripheral wall and has a second peripheral wall and a contact surface facing the first frame. The contact surface is provided with a magnetic element for attaching the first frame and a positioning element for alignment.

### BACKGROUND OF THE INVENTION

1. Technical Field

The invention relates to mobile phones, particularly to a frame of a mobile phone.

2. Related Art

A mobile phone is a device that can make and receive telephone calls over a radio link while moving around a wide geographic area. Mobile phones are used for a variety of purposes, including keeping in touch with family members, conducting business, and having access to a telephone in the event of an emergency. Some people carry more than one cell phone for different purposes, such as for business and personal use. Modern mobile phones, especially smartphones, become more and more precision because of more complexity and functions. As a result, they need better protection such as a plastic, rubber or metal protector frame. A protector frame can compass and protect a mobile phone from direct impact.

Metal protector frames can provide modern mobile phones with better toughness than plastic or rubber frames. A typical metal protector frame assembly is composed of a pair of L-shaped or U-shaped frames. Such a pair of frames needs to be fastened with each other. A typical fastening manner is to use one or two screws. Although a metal protector frame can protect a mobile phone very well, the screws which are directly exposed on the frame will spoil the appearance of the protector frame and the mobile phone which is embedded therein. Furthermore, the screws tend to be loosened or lost.

### SUMMARY OF THE INVENTION

An object of the invention is to provide a metal protector frame assembly which does not need any screw. This can improve the appearance thereof.

To accomplish the above object, the metal frame assembly of the invention includes a first frame and a second frame, which correspond to each other. The first frame has a first peripheral wall. The second frame is attached with the first peripheral wall and has a second peripheral wall and a contact surface facing the first frame. The contact surface is provided with a magnetic element for attaching the first frame and a positioning element for alignment.

### BRIEF DESCRIPTION OF THE DRAWINGS

FIG. 1 is an exploded view of the invention;

FIG. 2 is another exploded view of the invention;

FIG. 3 is a perspective view of the invention;

FIG. 4 is a sectional view of the invention;

FIG. 5 is a schematic view of the invention with a mobile phone; and

FIG. 6 is a sectional view of the invention with a mobile phone.

### DETAILED DESCRIPTION OF THE INVENTION

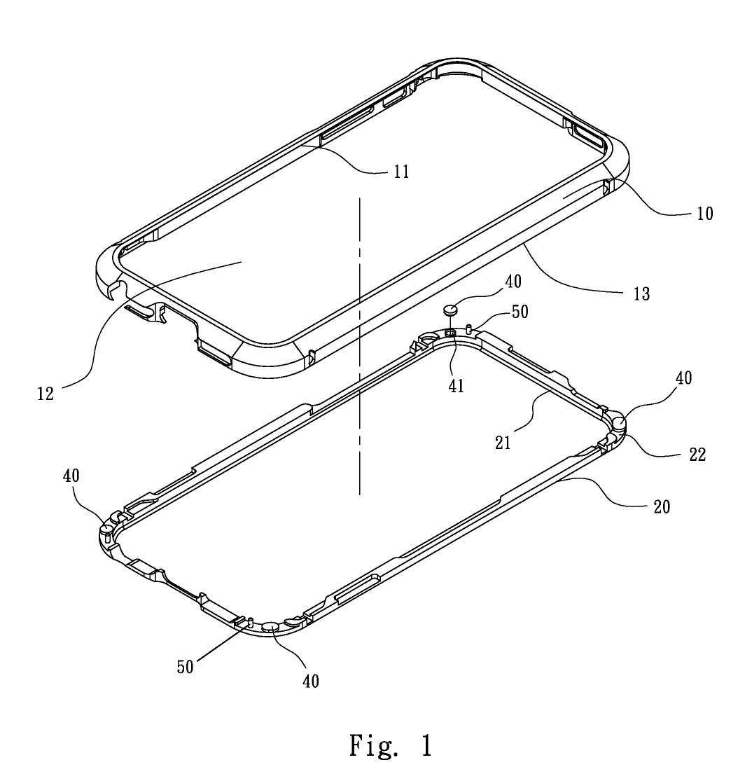

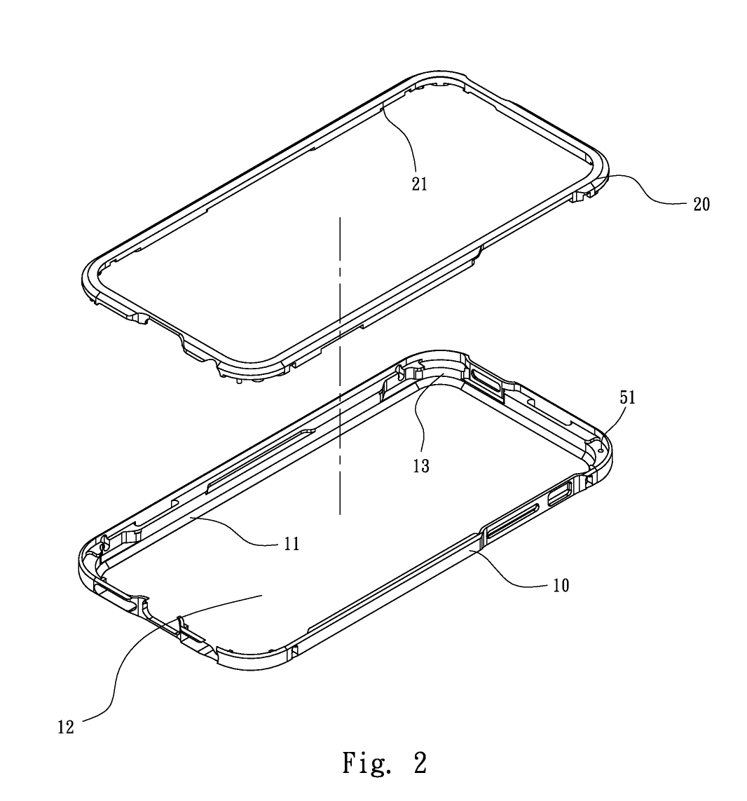

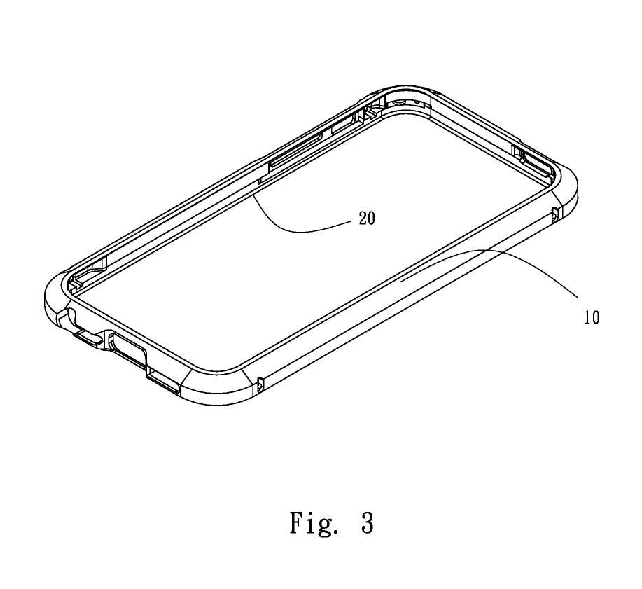

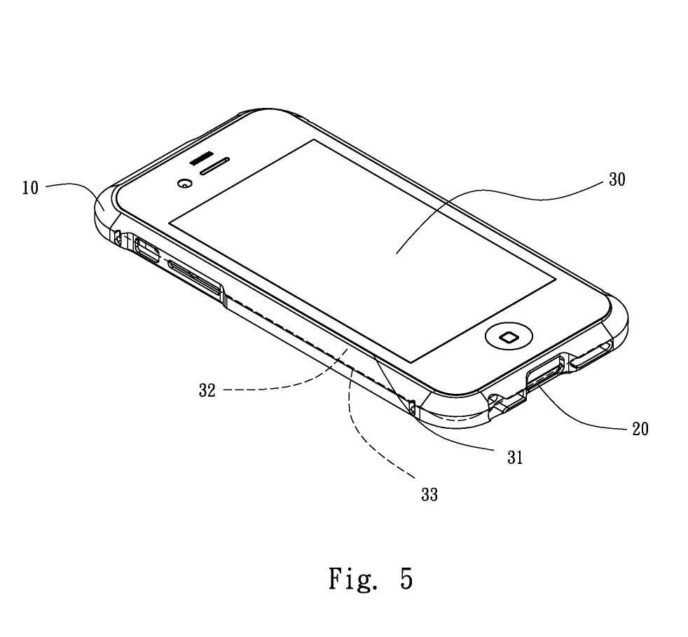

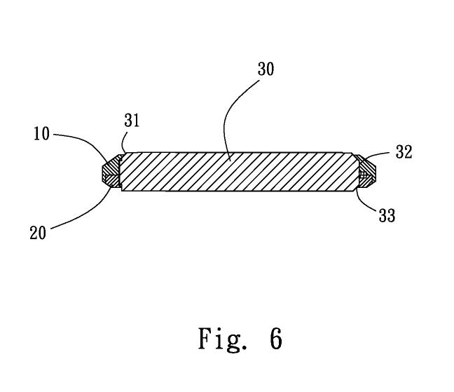

Please refer to FIGS. 1-6. The metal frame assembly of the invention is a hollow and substantially rectangular body which is used to compass a mobile phone. The frame assembly includes a first frame 10 and a second frame 20, which correspond to each other. As shown in FIG. 5, the first frame 10 and the second frame 20 are an upper portion corresponding to the front panel 31 of a mobile phone 30 and a lower portion corresponding to the back of the mobile phone 30.

The first frame 10 is formed with a front flange 11, a window 12 and a first peripheral wall 13. The front flange 11 smoothly abuts against the front panel 31 of the mobile phone 30. The window 12 is used to expose the front panel 31 of the mobile phone 30. The first peripheral wall 13 is a primary portion that compasses the mobile phone 30.

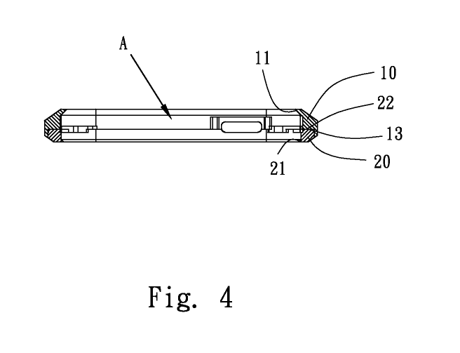

The second frame 20 is formed with a second peripheral wall 21 and a contact surface 22 facing the first frame 10. The contact surface 22 of the second frame 20 is attached with the first peripheral wall 13 of the first frame 10. As shown in FIG. 4, a receiving space A which is enclosed by the second peripheral wall 21 can be used to slightly tightly accommodate the mobile phone 30. The side edge 32 and peripheral portions of the front panel 31 and back 33 of the mobile phone 30 can be covered and protected by the metal frame assembly.

The contact surface 22 of the second frame 20 is provided with one or more magnetic elements 40 for attaching the first frame 10 and one or more positioning element 50 for alignment of the first and second frames 10, 20. By the magnetism between the magnetic element 40 and the first frame 10, the first and second frames 10, 20 can be firmly attached with each other without a screw. In the shown embodiment, there are four magnetic elements 40 on the second frame 20.

Preferably, the magnetic elements 40 may be of a button shape as shown, but not limited to this shape. The contact surface 22 is formed with one or more cavities 41 for receiving the one or more magnetic elements 40.

The positioning elements 50 are of a cylindrical shape and the first frame 10 is formed with one or more positioning holes 51 corresponding to the positioning elements 50 in shape and quantity.

It will be appreciated by persons skilled in the art that the above embodiment has been described by way of example only and not in any limitative sense, and that various alterations and modifications are possible without departure from the scope of the invention as defined by the appended claims.

What is claimed is:

1. A metal protector frame assembly, comprising:
a first frame, being a hollow body, and having a first peripheral wall; and
a second frame, being a hollow body corresponding to the first frame, attached with the first peripheral wall, and having a second peripheral wall and a contact surface facing the first frame;
wherein the contact surface is provided with a magnetic element for attaching the first frame and a positioning element for alignment.

2. The metal protector frame assembly of claim 1, wherein the positioning element is of a cylindrical shape.

3. The metal protector frame assembly of claim 2, wherein the first frame is formed with a positioning hole corresponding to the positioning element.

4. The metal protector frame assembly of claim 1, wherein magnetic element is of a button shape.

5. The metal protector frame assembly of claim 1, wherein the contact surface is formed with a cavity for receiving the magnetic element.
